(19) United States
(12) Patent Application Publication
(10) Pub. No.: US 2016/0283520 A1
(43) Pub. Date: Sep. 29, 2016

(54) SEARCH DEVICE, SEARCH METHOD, AND COMPUTER PROGRAM PRODUCT

(71) Applicant: Kabushiki Kaisha Toshiba, Tokyo (JP)

(72) Inventors: Yuto YAMAJI, Kawasaki Kanagawa (JP); Toshiaki NAKASU, Shinagawa Tokyo (JP); Tomoyuki SHIBATA, Kawasaki Kanagawa (JP)

(21) Appl. No.: 15/076,429

(22) Filed: Mar. 21, 2016

(30) Foreign Application Priority Data
Mar. 23, 2015 (JP) 2015-059922

(51) Int. Cl. G06F 17/30

(52) U.S. Cl. CPC G06F 17/30268; G06F 17/30867; G06F 17/3053; G06F 17/30554

(57) ABSTRACT

According to an embodiment, a search device includes a receiver, an extractor, a changer, and a searcher. The receiver that receive first data that specifies at least one item comprising an area, an attribute, a color, or a keyword of each of one or more structural element, and then to receive second specifying data obtained by modifying the first data. The extractor that extracts a first element having a difference in the second data from the first data. The changer is that changes a weight of an item corresponding to the difference. The searcher that searches for content based on an item of the first element, the changed weight of the item, an item of a second element that does not have a difference in the second data from the first data, and a weight of the item of the second element.

### CROSS-REFERENCE TO RELATED APPLICATION

This application is based upon and claims the benefit of priority from Japanese Patent Application No. 2015-059922, filed on Mar. 23, 2015; the entire contents of which are incorporated herein by reference.

### FIELD

Embodiments described herein relate generally to a search device, a method, and a computer program product.

### BACKGROUND

Conventionally, there is known a technique of searching for content by using in a query one or more keywords specified by a user. For example, JP 9-153061 A discloses a technique according to which a user changes the degree of importance of a keyword which the user deems important among one or more keywords and searches for content.

However, with a conventional technique as described above, a user himself/herself has to set a weight of an item which the user deems important among one or more items to be used for a search, and thus the operation is complicated and the burden on the user tends to be increased.

### BRIEF DESCRIPTION OF THE DRAWINGS

FIG. 1 is a configuration diagram illustrating an example of a search device according to a first embodiment;

FIG. 2 is an explanatory diagram of example input of specifying data according to the first embodiment;

FIG. 3 is a diagram illustrating an example of the specifying data according to the first embodiment;

FIG. 4 is a diagram illustrating examples of the specifying data and weight information according to the first embodiment;

FIG. 5 is a diagram illustrating examples of time-series specifying data according to the first embodiment;

FIG. 6 is a diagram illustrating a first structural element according to the first embodiment;

FIG. 7 is a diagram illustrating an example of first specifying data according to the first embodiment;

FIG. 8 is a diagram illustrating an example of second specifying data according to the first embodiment;

FIG. 9 is a diagram illustrating an example of the second specifying data according to the first embodiment;

FIG. 10 is a diagram illustrating an example of the second specifying data according to the first embodiment;

FIG. 11 is a diagram illustrating an example of the second specifying data according to the first embodiment;

FIG. 12 is a diagram illustrating an example of the second specifying data according to the first embodiment;

FIG. 13 is an explanatory diagram of an example of a method of determining a display color according to the first embodiment;

FIG. 14 is a diagram illustrating an example of the second specifying data according to the first embodiment;

FIG. 15 is a diagram illustrating example display of a search result according to the first embodiment;

FIG. 16 is a diagram illustrating example display of a search result according to the first embodiment;

FIG. 17 is a diagram illustrating example display of a search result according to the first embodiment;

FIG. 18 is a flow chart illustrating an example of processing according to the first embodiment;

FIG. 19 is a diagram illustrating an example of the specifying data according to the first embodiment;

FIG. 20 is a diagram illustrating example search results according to the first embodiment;

FIG. 21 is a diagram illustrating an example of the specifying data according to the first embodiment;

FIG. 22 is a diagram illustrating example search results according to the first embodiment;

FIG. 23 is an explanatory diagram of example input of specifying data according to an example modification 2;

FIG. 24 is a configuration diagram illustrating an example of a search device according to a second embodiment;

FIG. 25 is a diagram illustrating an example of a structural element before recognition according to the second embodiment;

FIG. 26 is a diagram illustrating an example of the structure element after recognition according to the second embodiment;

FIG. 27 is a diagram illustrating example display of a search result according to the second embodiment; and

FIG. 28 is a diagram illustrating an example hardware configuration of a search device according to each embodiment and each example modification.

### DETAILED DESCRIPTION

According to an embodiment, a search device includes a receiver, an extractor, a changer, a searcher, and a display controller. The receiver that receives input of first specifying data that specifies at least one item comprising an area, an attribute, a color, or a keyword of each of one or more structural elements, and, subsequent to receiving the first specifying data, the receiver further receiving input of second specifying data obtained by modifying the first specifying data. The extractor that extracts a first structural element having a difference in the second specifying data from the first specifying data. The changer that changes a weight of an item corresponding to the difference of the extracted first structural element. The searcher that searches for content based on an item of the first structural element, the changed weight of the item of the first structural element, an item of a second structural element that does not have a difference in the second specifying data from the first specifying data, and a weight of the item of the second structural element. The display controller that displays the content on a display.

Hereinafter, embodiments will be described in detail with reference to the appended drawings.

### First Embodiment

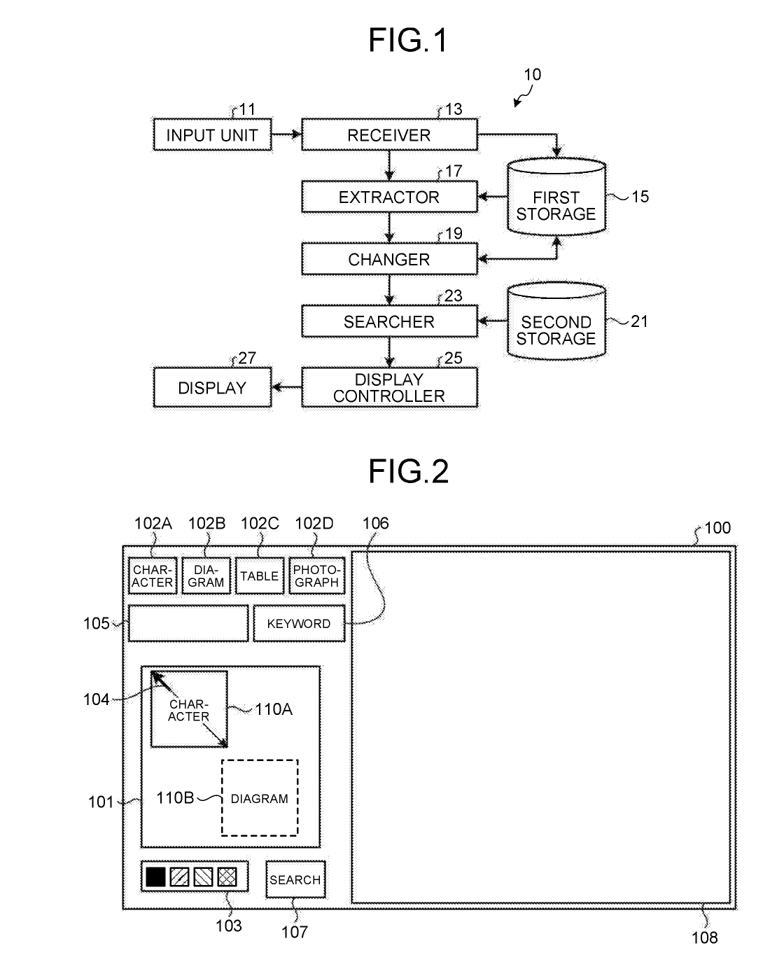

FIG. 1 is a configuration diagram illustrating an example of a search device 10 of a first embodiment. As illustrated in FIG. 1, the search device 10 includes an input unit 11, a receiver 13, a first storage 15, an extractor 17, a changer 19, a second storage 21, a searcher 23, a display controller 25, and a display 27.

The search device 10 may be realized by a tablet terminal, a smartphone, or a PC (Personal Computer), for example.

The input unit 11 may be realized by an input device such as a digital pen, a touch panel display, a mouse, or a keyboard, for example. The receiver 13, the extractor 17, the changer 19, the searcher 23, and the display controller 25 may be realized by causing a processing device such as a CPU (Central Processing Unit) to execute programs, that is, by software, or may be realized by hardware such as an IC (Integrated Circuit), or may be realized by using software and hardware in combination.

The first storage 15 and the second storage 21 may be realized by storage devices that are capable of magnetically, optically or electrically storing data, such as a HDD (Hard Disk Drive), an SSD (Solid State Drive), a memory card, an optical disk, a RAM (Random Access Memory), or a ROM (Read Only Memory). The display 27 may be realized by a display device such as a touch panel display or a liquid crystal display, for example.

The input unit 11 inputs specifying data for specifying at least one item among an area, an attribute, a color, and a keyword of each of one or more structural elements. The specifying data is a query for searching for search target content, and one or more structural elements are structural element(s) structuring the search target content, and the specifics of the structural element are identified by the area, the attribute, the color, and the keyword. That is, the specifying data is a query for searching for content, as the search target content, having a layout that is structured by the one or more structural elements.

The area indicates the area (the position and the size) of a structural element on a page. The attribute indicates whether the structural element is a character, a diagram, a table, or a photograph, but is not limited thereto. For example, the attribute may be broken down into a title and a list of items in the case of a character, a graph, a flow chart, a block diagram, and a map in the case of a diagram, a bar chart and a price table in the case of a table, and nature and an artificial object in the case of a photograph. The color indicates the color of the structural element. The keyword indicates a keyword used in the structural element. In the first embodiment, all of the items, the area, the attribute, the color, and the keyword, may be specified with respect to the structural element, but this is not restrictive.

As the search target content, a digital document such as a document created by document creation software, spreadsheet software, presentation software, document browser software or the like, and a Web page, a handwritten document created by a user inputting handwritten data and the like are assumed, but these are not restrictive, and a still image, a video and the like are also possible. For example, if the search target content is a thumbnail image of video data or an album image of music data, search for video data or music data may be performed.

FIG. 2 is an explanatory diagram of example input of specifying data according to the first embodiment. In the example illustrated in FIG. 2, an input window 101, a character button 102A, a diagram button 102B, a table button 102C, a photograph button 102D, a color button 103, a text box 105, a keyword button 106, a search button 107, and a search result display area 108 are arranged in a display screen 100 that is displayed by the display 27.

A user may input, in the input window 101, the area, the attribute, the color, and the keyword of a structural element by performing input of operation of a cursor 104 by the input unit 11, and may input specifying data.

For example, the user inputs the area of the structural element by operating the cursor 104 and inputting, in the input window 101, a closed loop drawn as a rectangle or a free curve.

Also, for example, the user selects a structural element in the input window 101 by operating the cursor 104, and inputs the attribute of the structural element by selecting one of the character button 102A, the diagram button 102B, the table button 102C, and the photograph button 102D. In the first embodiment, when the character button 102A is selected, a character is made the attribute of the structural element, when the diagram button 102B is selected, a diagram is made the attribute of the structural element, when the table button 102C is selected, a table is made the attribute of the structural element, and when the photograph button 102D is selected, a photograph is made the attribute of the structural element.

Furthermore, for example, the user selects a structural element in the input window 101 by operating the cursor 104, and inputs the color of the structural element by selecting from a color palette of the color button 103.

Moreover, for example, the user selects a structural element in the input window 101 by operating the cursor 104, and inputs a keyword of the structural element by inputting a keyword in the text box 105 and selecting the keyword button 106.

In the example illustrated in FIG. 2, a structural element 110A and a structural element 110B are input in the input window 101. Additionally, with respect to the structural element 110A, the attribute is a character, the color is black, and the keyword is empty, and with respect to the structural element 110B, the attribute is a diagram, the color is red, and the keyword is empty.

Then, the user operates the cursor 104 and selects the search button 107, and the search target content is searched for with the specifying data input in the input window 101 as the query, and the search result is displayed in the search result display area 108.

The receiver 13 receives input of the specifying data from the input unit 11, and stores the same in the first storage 15. For example, the receiver 13 receives specifying data that is input in the input window 101 (see FIG. 2) every time the search button 107 is selected, and stores the data in the first storage 15.

Generally, with content search, a user repeats the search while modifying the query until desired content is retrieved. Accordingly, in the first embodiment, the receiver 13 receives specifying data modified from previous specifying data in the chronological order, and stores the same in the first storage 15. As a result, pieces of specifying data modified from previous specifying data are stored in the first storage 15 in the chronological order.

Additionally, in the case where input for erasing all the pieces of specifying data input in the input window 101 (see FIG. 2) is received, the receiver 13 deletes all the pieces of specifying data that are stored in the chronological order in the first storage 15. This is because it is determined that search for content desired by the user is ended, or that the search is to be performed again from the start.

In the following, the latest specifying data received by the receiver 13 will be referred to as second specifying data, and the specifying data received by the receiver 13 before the second specifying data will be referred to as first specifying data. In the first embodiment, a case where the first specifying data is specifying data that is received by the receiver 13 immediately before the second specifying data, that is, a case where input of the second specifying data is received following input of the first specifying data, will be described as an example, but this is not restrictive.

The first storage 15 stores, in association with each other, the first specifying data and weight information indicating the weight of an item of each of one or more structural elements of the first specifying data.

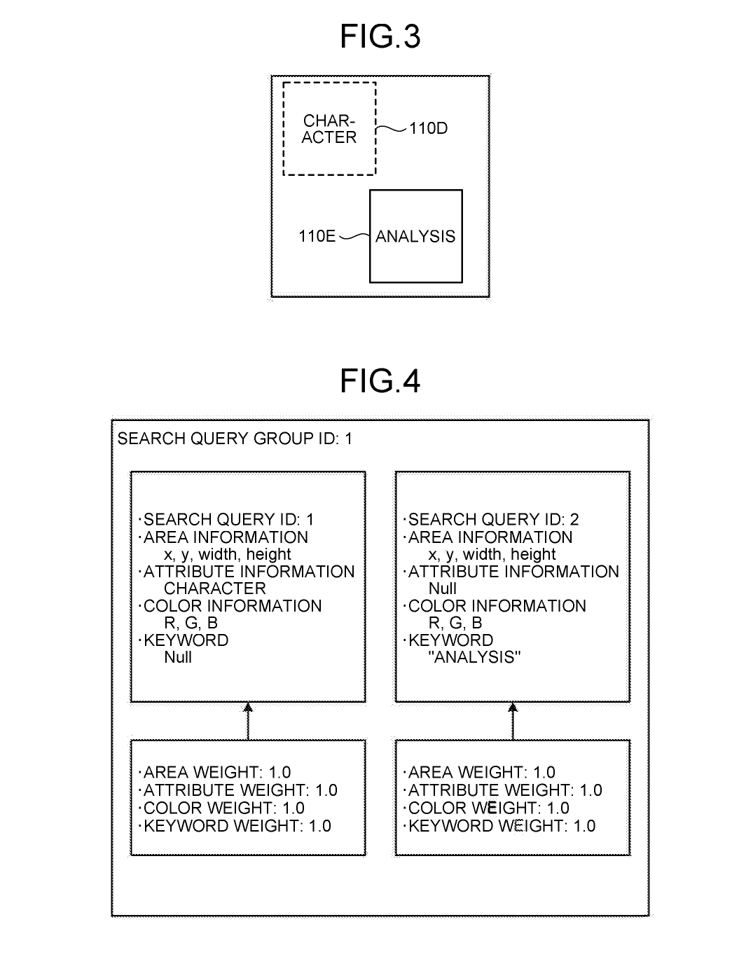

For example, as illustrated in FIG. 3, in the case where the first specifying data is structured from a structural element 110D and a structural element 110E, the first specifying data and the weight information are stored in the first storage 15 in the mode illustrated in FIG. 4.

Search query group ID: 1 is the ID of the first specifying data, search query ID: 1 is the ID of the structural element 110D, and search query ID: 2 is the ID of the structural element 110E.

The area is represented by the center coordinates (x, y), the width (wide), and the height (height), the attribute is represented by one of character, diagram, table, photograph, and Null, the color is represented by RGB, and the keyword is represented by the keyword itself or Null. Additionally, Null indicates empty.

In the example illustrated in FIG. 4, a default value of 1.0 is set for each of the weights of the area, the attribute, the color, and the keyword, but when the weight is changed by the changer 19 described later, the weight after change is set.

Additionally, the second specifying data is also stored in the first storage 15 in the mode described above, and weight information of the second specifying data is stored by the changer 19 described later.

The extractor 17 extracts a first structural element, which is a structural element for which there is a difference in the second specifying data from the first specifying data.

For example, the extractor 17 compares the search query ID of a structural element of the first specifying data and the search query ID of a structural element of the second specifying data, and if a structural element with a search query ID not present in the first specifying data is present in the second specifying data, this structural element is extracted as the first structural element.

Also, for example, the extractor 17 compares each of the area, the attribute, the color, and the keyword of a structural element of the first specifying data and of a structural element of the second specifying data with matching search query IDs, and if there is a non-matching item, this structural element is extracted as the first structural element.

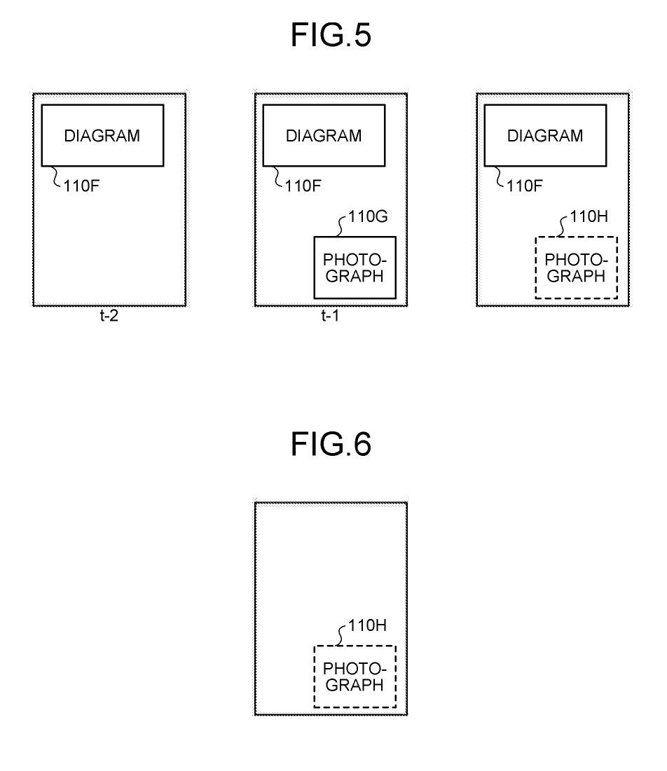

For example, in the example illustrated in FIG. 5, specifying data that is structured by a structural element 110F and a structural element 110G is assumed to be the first specifying data, specifying data that is structured by the structural element 110F and a structural element 110H is assumed to be the second specifying data, and the structural element 110H is assumed to be the structural element 110G whose color has been modified from black to red. In this case, the structural element 110G and the structural element 110H match each other in terms of search query ID but not in color, and thus, as illustrated in FIG. 6, the extractor 17 extracts the structural element 110H as the first structural element.

Additionally, if, when comparing the search query ID of a structural element of the first specifying data and the search query ID of a structural element of the second specifying data, a structural element with a search query ID not present in the second specifying data is present in the first specifying data, the extractor 17 does not extract this structural element as the first structural element. This is because the user has deleted this structural element from the second specifying data with the intention of not using the same for search.

The changer 19 changes the weight of the item which is the difference of the first structural element extracted by the extractor 17. The changer 19 changes the weight of the area in the case where the item which is the difference of the first structural element is the area, changes the weight of the attribute in the case where the item which is the difference of the first structural element is the attribute, changes the weight of the color in the case where the item which is the difference of the first structural element is the color, and changes the weight of the keyword in the case where the item which is the difference of the first structural element is the keyword.

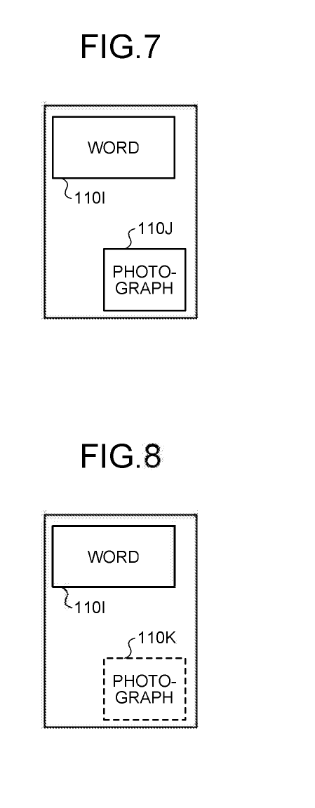

For example, it is assumed that the first specifying data is specifying data that is structured by a structural element 110I and a structural element 110J, as illustrated in FIG. 7, the second specifying data is specifying data that is structured by the structural element 110I and a structural element 110K, as illustrated in FIG. 8, and the structural element 110K is the structural element 110J whose color has been modified from black to red. In this case, the color of the structural element 110K is extracted by the extractor 17 as the item which is the difference of the first structural element, and the changer 19 changes the weight of the color of the structural element 110K.

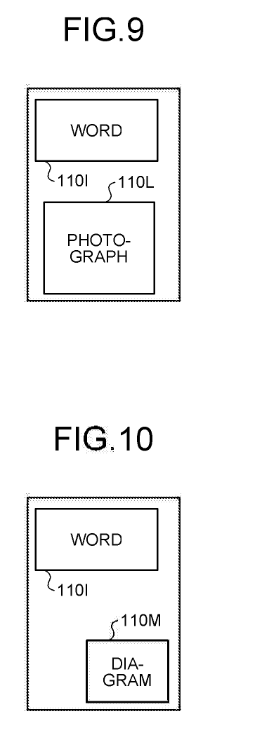

Furthermore, for example, it is assumed that the first specifying data is the specifying data illustrated in FIG. 7, the second specifying data is specifying data that is structured by the structural element 110I and a structural element 110L, as illustrated in FIG. 9, and the structural element 110L is the structural element 110J whose area has been modified. In this case, the area of the structural element 110L is extracted by the extractor 17 as the item which is the difference of the first structural element, and the changer 19 changes the weight of the area of the structural element 110L.

Moreover, for example, it is assumed that the first specifying data is the specifying data illustrated in FIG. 7, the second specifying data is specifying data that is structured by the structural element 110I and a structural element 110M, as illustrated in FIG. 10, and the structural element 110M is the structural element 110J whose attribute has been modified from a photograph to a diagram. In this case, the attribute of the structural element 110M is extracted by the extractor 17 as the item which is the difference of the first structural element, and the changer 19 changes the weight of the attribute of the structural element 110M.

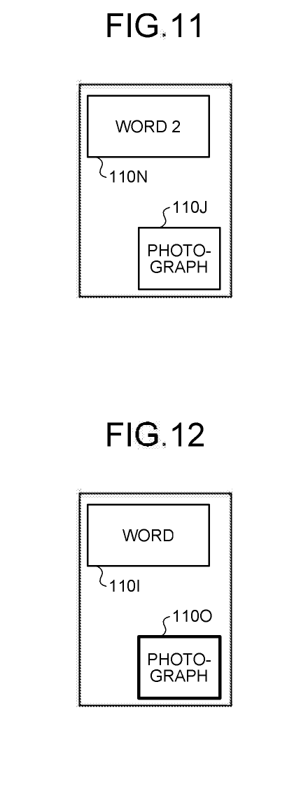

Moreover, for example, it is assumed that the first specifying data is the specifying data illustrated in FIG. 7, the second specifying data is specifying data that is structured by a structural element 110N and the structural element 110J, as illustrated in FIG. 11, and the structural element 110N is the structural element 110I whose keyword has been modified from a word to a word 2. In this case, the keyword of the structural element 110N is extracted by the extractor 17 as the item which is the difference of the first structural element, and the changer 19 changes the weight of the keyword of the structural element 110N.

Still further, for example, it is assumed that the first specifying data is the specifying data illustrated in FIG. 7, the second specifying data is specifying data that is structured by the structural element 110I and a structural element 110O, as illustrated in FIG. 12, and the structural element 110O is obtained by double input of the structural element 110J. In this case, all of the items, the area, the attribute, the color, and the keyword, of the structural element 110O are extracted by the extractor 17 as the items which are the differences of the first structural element, and the changer 19 changes the weight of each item of the structural element 110O.

Additionally, in the case where a structural element that is not present in the first specifying data is extracted by the extractor 17 as the first structural element, the item which is the difference of the first structural element is an item among the area, the attribute, the color, and the keyword whose value is not Null, and the changer 19 changes the weight of this item.

Specifically, the changer 19 acquires the weight information of the first specifying data from the first storage 15 and takes the same as the weight information of the second specifying data, and changes the weight in the case where the weight information indicates the weight of an item which is the difference of the first structural element, and changes the default weight in the case where the weight information does not indicate the weight of an item which is the difference of the first structural element.

Additionally, in the case of changing the weight of an item which is the difference of the first structural element extracted by the extractor 17, the changer 19 changes the weight of the item by a specific value. Accordingly, in the case where the weight information of the second specifying data indicates the weight of an item which is the difference of the first structural element, the changer 19 takes, as the weight of the item, a weight obtained by adding a specific value to the aforementioned weight, and in the case where the weight information does not indicate the weight of an item which is the difference of the first structural element, the changer 19 takes, as the weight of the item, a weight obtained by adding the specific value to the default weight.

Then, the changer 19 stores the weight information after change in the first storage 15 in association with the second specifying data.

As described above, since the weight information of the first specifying data is taken as the weight information of the second specifying data, and the weight indicated by the weight information is changed, the weight of past specifying data may be reflected in the weight of the latest specifying data.

For example, as described above, in the case of the example illustrated in FIG. 5, the color of the structural element 110H is extracted by the extractor 17 as the item which is the difference of the first structural element, and thus the changer 19 changes the weight of the color of the structural element 110H.

Here, if the specifying data structured by the structural element 110F is taken as the first specifying data at a time point t-2, and the specifying data structured by the structural element 110F and the structural element 110G is taken as the first specifying data at a time point t-1, the first specifying data at the time point t-1 is the first specifying data at the time point t-2 to which the structural element 110G is added. Additionally, the keyword of the structural element 110G is assumed to be Null.

Thus, when comparing the first specifying data at the time point t-2 and the second specifying data, the differences are the area, the attribute, and the color×2 of the structural element 110G, but changes in the weights of the area, the attribute, and the color of the structural element 110G are reflected in the weight information of the first specifying data at the time point t-1.

Accordingly, the changer 19 may reflect the weights of all the differences from the first specifying data at the time point t-2 to the second specifying data in the weight information of the second specifying data by taking the weight information of the first specifying data at the time point t-1 as the weight information of the second specifying data and changing the weight of the color of the structural element 110H.

Additionally, here, an example is described where the weight of an item which is the difference of the first structural element is changed by a specific value, but this is not restrictive, and the weight of an item which is the difference of the first structural element may be changed according to the degree of modification of the item.

For example, in the case where the item which is the difference of the first structural element is the area, the changer 19 calculates the difference between the area of the first structural element of the first specifying data and the area of the first structural element of the second specifying data by using information such as the overlapping ratio, the centroid distance, the area ratio, a change in the shape (the aspect ratio, etc.) and the like, and normalizes the calculated value to between 0.0 and 1.0. Then, in the case where the weight information of the second specifying data indicates the weight of the area of the first structural element, the changer 19 may take, as the weight of the area, a weight obtained by adding the normalized value to the weight, and in the case where the weight information does not indicate the weight of the area of the first structural element, the changer 19 may take, as the weight of the area, a weight obtained by adding the normalized value to the default weight.

Also, for example, in the case where the item which is the difference of the first structural element is the attribute, the changer 19 calculates the difference between the attribute of the first structural element of the first specifying data and the attribute of the first structural element of the second specifying data by using information such as the correlation between the attributes, and normalizes the calculated value to between 0.0 and 1.0. A higher correlation between the attributes takes a smaller value. For example, a table includes many characters, and thus the correlation between a table and a character is high, and a photograph does not include characters and ruled lines, and thus the correlation between a table and a photograph is low. Additionally, the normalized value may simply be made 0.0 if the attributes match, and the normalized value may simply be made 1.0 if the attributes do not match, for example. Then, in the case where the weight information of the second specifying data indicates the weight of the attribute of the first structural element, the changer 19 may take, as the weight of the attribute, a weight obtained by adding the normalized value to the weight, and in the case where the weight information does not indicate the weight of the attribute of the first structural element, the changer 19 may take, as the weight of the attribute, a weight obtained by adding the normalized value to the default weight.

Moreover, for example, in the case where the item which is the difference of the first structural element is the color, the changer 19 calculates the difference between the color of the first structural element of the first specifying data and the color of the first structural element of the second specifying data by using information such as the distance in RGB color space, the distance in HSV color space, the distance in L*a*b* color space or the like, and normalizes the calculated value to between 0.0 and 1.0. Then, in the case where the weight information of the second specifying data indicates the weight of the color of the first structural element, the changer 19 may take, as the weight of the color, a weight obtained by adding the normalized value to the weight, and in the case where the weight information does not indicate the weight of the color of the first structural element, the changer 19 may take, as the weight of the color, a weight obtained by adding the normalized value to the default weight.

Moreover, for example, in the case where the item which is the difference of the first structural element is the keyword, the changer 19 calculates the difference between the keyword of the first structural element of the first specifying data and the keyword of the first structural element of the second specifying data by using information such as the proportion of the number of changed characters, the similarity in semantic meaning, and the like, and normalizes the calculated value to between 0.0 and 1.0 Then, in the case where the weight information of the second specifying data indicates the weight of the keyword of the first structural element, the changer 19 may take, as the weight of the keyword, a weight obtained by adding the normalized value to the weight, and in the case where the weight information does not indicate the weight of the keyword of the first structural element, the changer 19 may take, as the weight of the keyword, a weight obtained by adding the normalized value to the default weight.

Additionally, a method of calculating the similarity between semantic meanings is disclosed in Nguyen Viet Ha et al.: “A Large-scale Knowledge Base for Measuring Semantic Similarity between Words”, Journal of Information Processing, Vo. 23, No, 10, 2002.

The second storage 21 stores a plurality of pieces of content. As the content, a digital document such as a document or a Web page, a handwritten document, and the like may be cited, as described above.

The searcher 23 searches for content based on an item of the first structural element, the weight after change of the item, an item of a second structural element, which is a structural element for which there is no difference in the second specifying data from the first specifying data, and the weight of the item.

The weight of an item of the second structural element is the weight of the item of the second structural element indicated by the weight information of the second specifying data. Additionally, the weight of the item of the second structural element is not changed by the changer 19, and thus the weight of the item of the second structural element indicated by the weight information of the second specifying data is the same as the weight of the item of the second structural element indicated by the weight information of the first specifying data.

Specifically, the searcher 23 calculates, for each of a plurality of pieces of content stored in the second storage 21, a first weighted similarity by calculating a first similarity to the item of the first structural element and multiplying by the weight after change of the item of the first structural element, and a second weighted similarity by calculating a second similarity to the item of the second structural element and multiplying by the weight of the item of the second structural element, and calculates a likelihood which is a mean of the first weighted similarity and the second weighted similarity. Then, the searcher 23 searches, among a plurality of pieces of content, for content whose likelihood exceeds a threshold value (an example of a first threshold value).

Additionally, in the case where content that is stored in the second storage 21 is a digital document, information capable of identifying the area, the attribute, the color, and the keyword of a structural element of the content is included as meta information. Accordingly, in the case where content is a digital document, the area, the attribute, the color, and the keyword of the structural element may be identified by analyzing the content.

Incidentally, in the case where the structural element is a rasterized object such as a photograph, the color is identified by analyzing the object. For example, bins may be prepared by equally dividing a color space, and a vote may be cast for a closest bin based on the color information of each pixel of an object to thereby generate a color histogram, and this color histogram may be used for the color of the structural element. Additionally, with respect to each bin in the color histogram, a value equal to or greater than a threshold value may be changed to one; a value smaller than the threshold value may be changed to zero. This allows the color histogram to be not dominated by the background color, and the color at one point to be easily identified.

Furthermore, in the case where content that is stored in the second storage 21 is a handwritten document, the area, the attribute, the color, and the keyword of a structural element of the content may be identified by analyzing the class to which each stroke structuring the handwritten data belongs or the position. The class is at least one of a character, a figure, a table, an image, a drawing, a formula, a map, a memorandum added by the user, and the like.

Additionally, the class to which a stroke belongs may be determined by a method of structuring a set of strokes into a spatial or temporal group and determining, based on units of structure, the class to which a stroke belonging to a structure belongs, or a method of extracting, for each stroke, one or more peripheral strokes present around the stroke, calculating a combination feature regarding the feature of a combination of the stroke and the one or more peripheral strokes extracted, and determining a class to which the stroke belongs based on the calculated combination feature, for example.

The combination feature includes a first feature indicating the relationship between the target stroke and at least one of one or more peripheral strokes. Also, the combination feature includes a second feature that uses a summed value which is a sum of the feature regarding the shape of the target stroke and the feature regarding the shape of each of the one or more peripheral strokes.

The first feature is at least one of the similarity in the shape of the target stroke and at least one of the one or more peripheral strokes, and an identification value for identifying the positional relationship between the target stroke and at least one of the one or more peripheral strokes.

The similarity in the shape is the similarity, between the target stroke and at least one of the one or more peripheral strokes, regarding at least one of the length, the sum of curvature, the direction of the principal component, the bounding rectangle area, the bounding rectangle length, the bounding rectangle aspect ratio, the distance between a start point and an end point, the directional density histogram, and the number of bending points. That is, the similarity in shape may be a similarity between the stroke feature of the target stroke and the stroke feature of at least one of the one or more peripheral strokes.

The identification value is at least one of the overlapping ratio, the centroid distance, the direction of the centroid distance, the end point distance, the direction of the end point distance, and the number of intersection points of the bounding rectangles of the target stroke and at least one of the one or more peripheral strokes.

The second feature is at least the ratio of the sum of the length of the target stroke and the length of each of the one or more peripheral strokes to the bounding rectangle length of the combination, the summed value of the directional density histograms of the target stroke and the one or more peripheral strokes, and the ratio of the sum of the bounding rectangle area of the target stroke and the bounding rectangle area of each of the one or more peripheral strokes to the bounding rectangle area of the combination, for example.

Now, a content search method will be described.

First, the searcher 23 acquires, from the second storage 21, content for which the likelihood is not yet calculated, and calculates the similarity in the area between the first structural element and each structural element structuring the content. The similarity in the area is calculated by using the overlapping ratio, the centroid distance, the area ratio, a change in the shape (the aspect ratio), and the like.

Next, the searcher 23 calculates the similarities in the attribute, the color, and the keyword between the first structural element and a structural element, among the structural elements, with the highest similarity in the area to the first structural element (hereinafter such a structural element will be referred to as a “corresponding structural element”).

The similarity in the color may be the similarity between a predetermined bin in the color histogram corresponding to the RGB of the first structural element and a predetermined bin in the color histogram corresponding to the RGB of the corresponding structural element. A predetermined bin may be the bin of the color specified by the specifying data, for example. Additionally, in the case where a plurality of colors is specified by the specifying data, the bin of each specified color may be entered into a histogram as the similarity. The similarity between the histograms is determined by calculating the Bhattacharyya distance.

The similarity in the attribute may be 1.0 for matching attributes, and 0.0 for non-matching attributes, for example. Additionally, as described with reference to the changer 19, the similarity may be determined by using information such as the correlation between the attributes.

The similarity in the keyword may be 1.0 if the keyword of the first structural element is included in the character strings in the corresponding structural element, and 0.0 if the keyword is not included, or the similarity between each word structuring the character string in the corresponding structural element and the keyword of the first structural element may be calculated, and the similarity with the highest value may be taken as the similarity, for example. The method described with reference to the changer 19 may be used for the calculation of the similarity.

Then, the searcher 23 calculates the first weighted similarity by multiplying the similarity of the area, the similarity of the color, the similarity of the attribute, and the similarity of the keyword of the first structural element, respectively, by the weight of the area, the weight of the color, the weight of the attribute, and the weight of the keyword of the first structural element indicated by the weight information of the first specifying data, and adding up the same.

Furthermore, the searcher 23 calculates the second weighted similarity by the same method as for the first weighted similarity, and calculates a likelihood which is a mean of the first weighted similarity and the second weighted similarity.

The searcher 23 determines the likelihood by the method described above for each piece of content stored in the second storage 21, and retrieves content whose likelihood exceeds a threshold value.

Additionally, in the case of calculating the first similarity, the searcher 23 may calculate by a similarity calculation method according to the degree of modification of an item which is the difference. Specifically, in the case where the degree of modification is below a threshold value (an example of a second threshold value), the searcher 23 may calculate by a similarity calculation method by which the similarity is not easily increased, and in the case where the degree of modification is at or above the threshold value (an example of the second threshold value), the searcher 23 may calculate by a similarity calculation method by which the similarity is easily increased. Additionally, the degree of modification may be determined by the method described with reference to the changer 19.

Specifically, as the similarity calculation method by which the similarity is not easily increased, a method of precisely determining the similarity may be cited. In this case, with respect to the area, the similarity in the area may be determined with emphasis on a change in the shape. Also, with respect to the attribute, the similarity in the attribute may be determined by using the specifics of the corresponding structural element. Furthermore, with respect to the color, the similarity in the color may be determined by using the color proportion of the color histogram. Moreover, with respect to the keyword, the similarity in the keyword may be determined taking into account the position of the keyword included in the corresponding structural element.

Specifically, as the similarity calculation method by which the similarity is easily increased, a method of simply determining the similarity may be cited. In this case, with respect to the area, the similarity in the area may be determined by variably magnifying the area of the first structural element by a specific proportion. Also, with respect to the attribute, the similarity in the attribute may be determined by broadening the correlation between the attributes. Furthermore, with respect to the color, the similarity in the color may be determined by using bins in the color histogram that are close in the color space. Moreover, with respect to the keyword, the similarity in the keyword may be determined by broadening the correlation between words.

The display controller 25 displays the content retrieved by the searcher 23 on the display 27 (for example, the search result display area 108 in FIG. 2). Additionally, the display controller 25 may display at least one of the first structural element and the second structural element by superimposing the same on the retrieved content.

For example, an object corresponding to the structural element, of the first structural element and the second structural element, having the highest similarity in the area may be displayed being superimposed on the retrieved content, or objects corresponding to the first structural element and the second structural element, respectively, may be displayed being superimposed on the retrieved content.

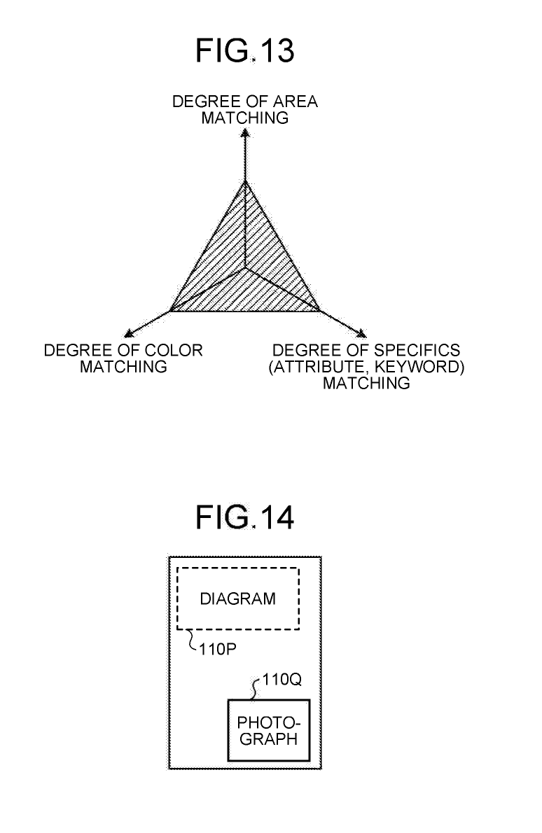

Also, the color of the object to be superimposed may be changed according to the similarity in the area, the similarity in the attribute, the similarity in the color, and the similarity in the keyword calculated by the searcher 23. For example, as illustrated in FIG. 13, the color of the object may be changed to a color that is determined by causing the degree of area matching (the similarity in the area), the degree of color matching (the similarity in the color), and the degree of specifics matching (the mean value of the similarity in the attribute and the similarity in the keyword) to correspond to the RGB.

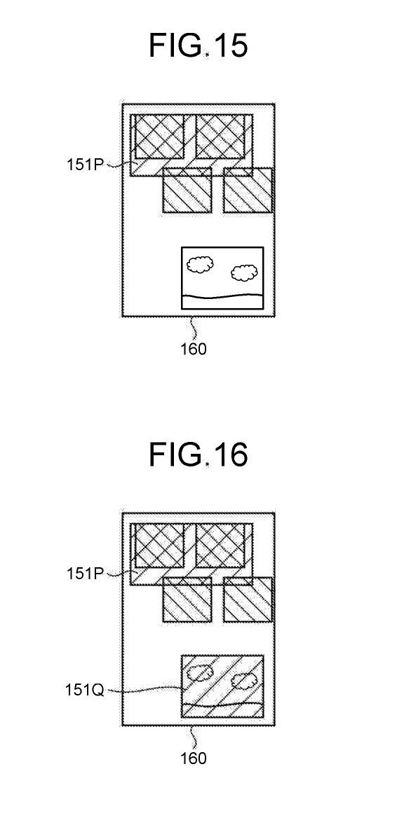

For example, as illustrated in FIG. 14, it is assumed that the second specifying data is specifying data that is structured by a structural element 110P and a structural element 110Q, and that the structural element with the highest degree of area matching is the structural element 110P. In this case, as illustrated in FIG. 15, the display controller 25 displays an object 151P corresponding to the structural element 110P by superimposing the same on retrieved content 160, and causes the color of the object 151P to be the color that is determined by the method described above.

Also, for example, as illustrated in FIG. 13, the color of the object may be changed according to the area of a triangle that is determined by the degree of area matching (the similarity in the area), the degree of color matching (the similarity in the color), and the degree of specifics matching (the mean value of the similarity in the attribute and the similarity in the keyword).

Furthermore, as illustrated in FIG. 14, it is assumed that the second specifying data is specifying data that is structured by the structural element 110P and the structural element 110Q. In this case, as illustrated in FIG. 16, the display controller 25 displays the object 151P corresponding to the structural element 110P and an object 151Q corresponding to the structural element 110Q by superimposing the same on the retrieved content 160, and causes the colors of the object 151P and the object 151Q to be the colors that are determined by the method described above.

Furthermore, for example, a triangle that is determined by the degree of area matching (the similarity in the area), the degree of color matching (the similarity in the color), and the degree of specifics matching (the mean value of the similarity in the attribute and the similarity in the keyword), as illustrated in FIG. 13, may be superimposed by being combined with the object.

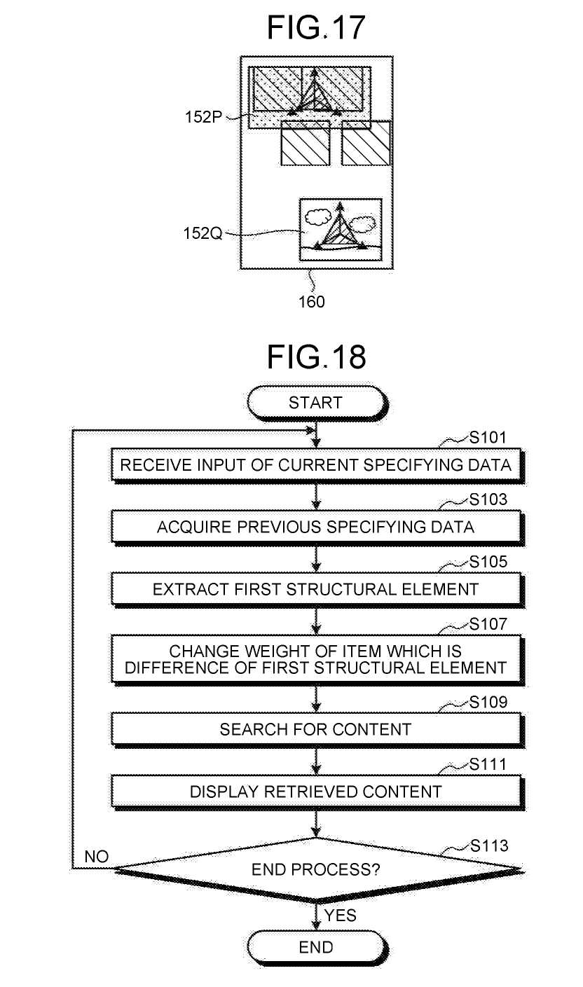

For example, as illustrated in FIG. 14, it is assumed that the second specifying data is specifying data that is structured by the structural element 110P and the structural element 110Q. In this case, as illustrated in FIG. 17, the display controller 25 displays an object 152P corresponding to the structural element 110P and an object 152Q corresponding to the structural element 110Q by superimposing the same on the retrieved content 160, and combines the triangle determined by the method described above with the object 152P and the object 152Q.

Additionally, the color of the object to be superimposed may be changed according to the weight of each item instead of the similarity of each item. In this case, the similarity of each item in the method described above may be replaced by the weight of each item.

Also, in the case where a plurality of pieces of content are retrieved by the searcher 23, the display controller 25 displays the retrieved pieces of content in the search result display area 108 (see FIG. 2) in the descending order of likelihood. Furthermore, the display controller 25 may also display that search is performed taking into account not only the latest specifying data (the second specifying data) but also the past specifying data (the first specifying data).

FIG. 18 is a flow chart illustrating an example of the flow of processing performed by the search device 10 according to the first embodiment.

First, the receiver 13 receives input of current specifying data from the input unit 11, and stores the same in the first storage 15 (step S101).

Next, the extractor 17 acquires the previous specifying data from the first storage 15 (step S103), and extracts the first structural element which is the structural element for which there is a difference in the current specifying data from the previous specifying data (step S105).

Subsequently, the changer 19 acquires the weight information of the previous specifying data from the first storage 15 as the weight information of the current specifying data, and in the case where the weight information indicates the weight of an item which is the difference of the first structural element, this weight is changed, and in the case where the weight information does not indicate the weight of an item which is the difference of the first structural element, the default weight is changed, and the weight information after change is stored in the first storage 15 in association with the current specifying data (step S107).

Then, the searcher 23 calculates, for each of a plurality of pieces of content stored in the second storage 21, the first weighted similarity by calculating a first similarity to the item of the first structural element and multiplying by the weight after change of the item of the first structural element, and the second weighted similarity by calculating a second similarity to the item of the second structural element and multiplying by the weight of the item of the second structural element, calculates a likelihood which is a mean of the first weighted similarity and the second weighted similarity, and searches, among a plurality of pieces of content, for content whose likelihood exceeds a threshold value (step S109).

Then, the display controller 25 displays the content retrieved by the searcher 23 on the display 27 (step S111).

Next, in the case where the process is not ended and re-search is to be performed (No in step S113), the process is returned to step S101, and in the case where re-search is not to be performed (Yes in step S113), the process is ended.

As described above, according to the first embodiment, when specifying data, which is a query, is modified, the weight of the item of the modified structural element is automatically changed, and thus content may be searched for while easily reflecting the intention of the user regarding search in the weight of the item of the structural element.

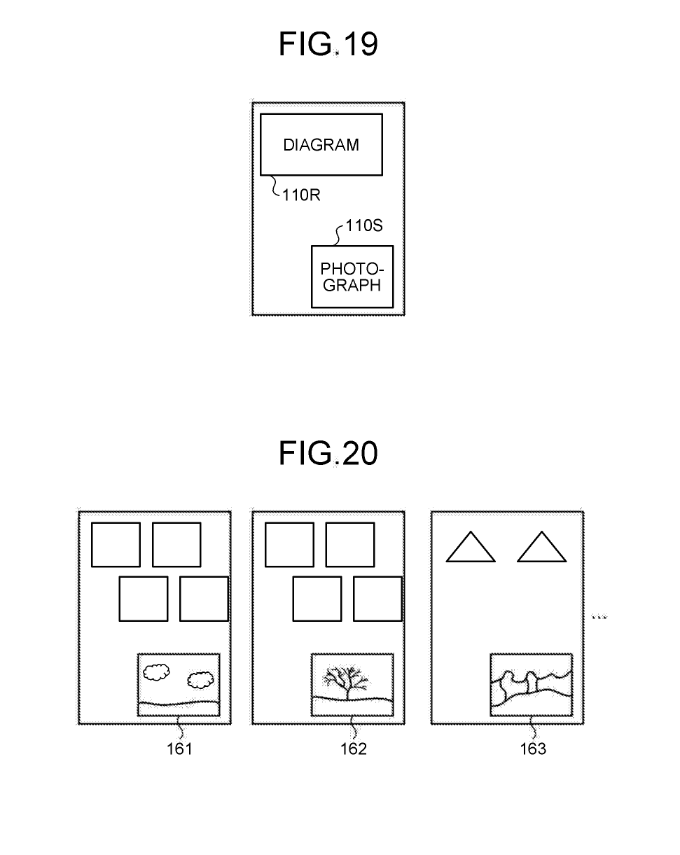

For example, it is assumed that content is searched for by specifying data structured by a structural element 110R and a structural element 110S, as illustrated in FIG. 19, and as a result, each piece of content illustrated in FIG. 20 is retrieved. Since the color of the structural element 110S is black, structural elements 161 to 163, in pieces of content illustrated in FIG. 20, corresponding to the structural element 110S are structural elements with black color or a color close to black such as navy.

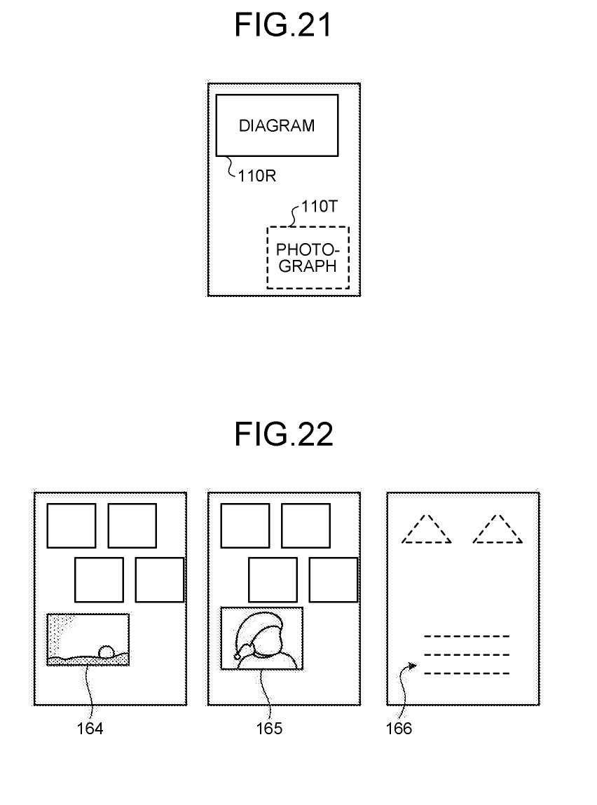

Here, it is assumed that the color of the structural element corresponding to the structural element 110S of the content desired by the user is red, and that content is searched for again by specifying data structured by the structural element 110R and a structural element 110T, which is the structural element 110S whose color has been changed from black to red, as illustrated in FIG. 21.

In this case, in the first embodiment, the weight of the color of the structural element 110T is increased, and in the re-search, search is performed with emphasis on the color of the structural element 110T, and as illustrated in FIG. 22, structural elements 164 to 166, in pieces of re-retrieved content, corresponding to the structural element 110T are structural elements with red color.

Additionally, in the case where search is performed with no emphasis on the color of the structural element 110T, structural elements, in pieces of re-retrieved content, corresponding to the structural element 110T are expected to include structural elements with colors other than red, and the re-search result as illustrated in FIG. 22 is not obtained.

### Example Modification 1

In the embodiment described above, an example where the weight of an item which is the difference of the first structural element is increased is described, but it is also possible to specify increase or decrease. In this case, a button for specifying increase or decrease may be added to the screen illustrated in FIG. 2. Then, the changer 19 may increase the weight of an item which is the difference of the first structural element in the case where increase is specified, and may reduce the weight of the item which is the difference of the first structural element in the case where decrease is specified.

### Example Modification 2

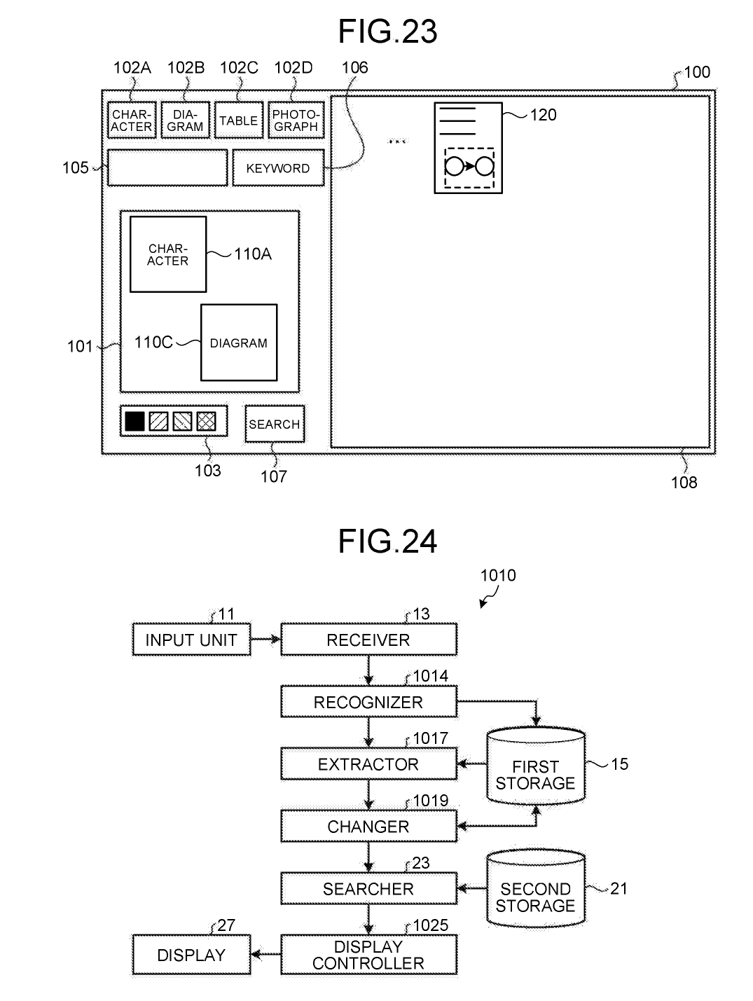

It is possible to allow, in the embodiment described above, specification of a structural element of specifying data from a search result. For example, in the example illustrated in FIG. 23, by selecting a figure on the lower side in content 120 displayed in the search result display area 108, a structural element 110C may be input in the input window 101.

### Second Embodiment

In a second embodiment, an example where specifying data is input by being handwritten will be described. In the following, differences to the first embodiment will be mainly described, and structural elements having the same functions as those in the first embodiment will be denoted by the same names or reference signs as in the first embodiment, and description thereof will be omitted.

FIG. 24 is a configuration diagram illustrating an example of a search device 1010 according to the second embodiment. As illustrated in FIG. 24, in the second embodiment, the search device 1010 is different from the first embodiment with respect to a recognizer 1014, an extractor 1017, a changer 1019, and a display controller 1025.

Specifying data is input by the input unit 11 by being handwritten. For example, the input unit 11 inputs in the input window 101 illustrated in FIG. 2 specifying data that is handwritten by a digital pen or the like.

The recognizer 1014 recognizes the specifying data received by the receiver 13, and stores specifying data before recognition and the specifying data after recognition in association with each other in the first storage 15.

In the case where the specifying data is handwritten, the specifying data is expressed by a set of time-series strokes from placing down of the pen to removal thereof. Each stroke is expressed by a set of pieces of information about two-dimensional points (x, y) arranged in the chronological order, the color of the stroke, the pen pressure of the stroke, and the like.

The recognizer 1014 recognizes, from the specifying data, a stroke group structuring a closed loop in the area of a structural element. Also, the recognizer 1014 performs character recognition of a stroke group present within the stroke group structuring the closed loop, and if there is a word indicating an attribute such as a character, a diagram, a table or a photograph, the attribute of the word which has been recognized is taken as the attribute of the structural element, and if there is a word indicating other than the attribute, the word which has been recognized is taken as the keyword of the structural element.

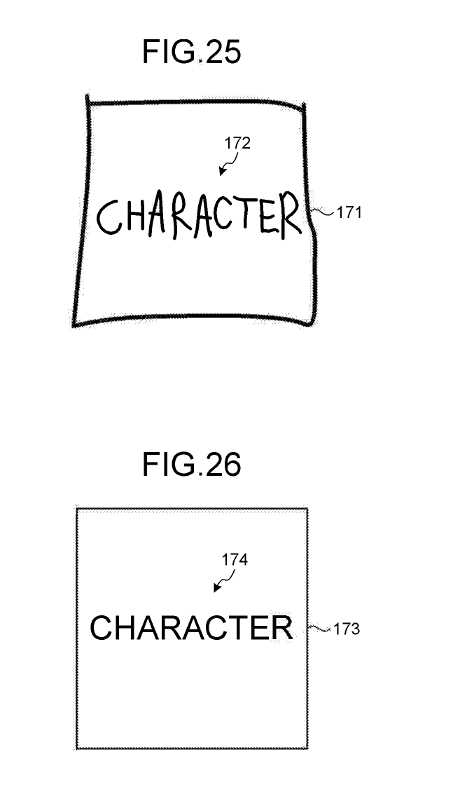

For example, as illustrated in FIG. 25, in the case where specifying data includes a stroke group 171 structuring a closed loop and a stroke group 172 that is present within the stroke group 171, the recognizer 1014 recognizes the stroke group 171 in an area 173 of the structural element, and recognizes the stroke group 172 to be an attribute (character) 174 of the structural element, as illustrated in FIG. 26.

Also, the recognizer 1014 sorts the colors of the stroke group structuring the closed loop and the stroke group that is present within the aforementioned stroke group into a histogram, and recognizes the color of the structural element. In the case where the stroke group includes a plurality of colors, a vote may be case for a bin in the color histogram based on the number of strokes of the same color, or the value used for casting a vote may be changed according to the length of the stroke.

Furthermore, the recognizer 1014 may recognize specification of increase or decrease in a weight, described in the example modification 1, based on the pen pressure of the stroke. In this case, the pen pressures of strokes of the stroke group structuring the close loop and of the stroke group that is present within the aforementioned stroke group are averaged, and if the value is at or above a threshold value, specification of increase in the weight for the structural element recognized based on the stroke group structuring the closed loop and the stroke group that is present within the aforementioned stroke group may be recognized, and if the value is below the threshold value, specification of decrease of the weight for the structural element may be recognized.

Also, in the case where the stroke group structuring the closed loop and the stroke group that is present within the aforementioned stroke group are doubly written, or a circling or underlining stroke is included in the stroke group that is present inside, the recognizer 1014 may recognize specification of increase in the weight for the structural element that is recognized based on the stroke group structuring the closed loop and the stroke group that is present within the aforementioned stroke group.

With respect to double-writing, double-writing may be recognized if the matching rate of strokes is at or above a threshold value.

With respect to circling, if there is, in the stroke group that is present within the stroke group structuring a closed loop, a stroke whose start point and end point are within a specific distance and whose length is specific times the diagonal length of the bounding rectangle, and there is a stroke group within this stroke, this stroke may be recognized as a circling stroke. Additionally, the bounding rectangle is a rectangle that circumscribes the stroke.

Additionally, if circling is unicursally repeated several times, specification of the amount of change in the weight may be recognized based on the number of repetitions. In this case, if the number of intersection points with the base stroke is at or above a threshold value, unicursal circling may be recognized to have been repeated several times, and the number of times of passing near the start point may be recognized as the number of repetitions.

With respect to underlining, if there is, in the stroke group that is present within the stroke group structuring a closed loop, a stroke whose start point and end point are separated by a specific distance or more, and whose curvature is within a specific curvature, and there is a stroke group within a rectangle obtained by expanding the stroke bounding rectangle in the upward direction by a specific width, this stroke may be recognized as an underlining stroke.

Furthermore, in the case where a character “!” is recognized in the stroke group that is present within the stroke group structuring the closed loop, the recognizer 1014 may recognize specification of increase in the weight for the structural element that is recognized based on the stroke group structuring the closed loop and the stroke group that is present within the aforementioned stroke group, and in the case where a character “?” is recognized in the stroke group that is present within the stroke group structuring the closed loop, the recognizer 1014 may recognize specification of decrease in the weight for the structural element that is recognized based on the stroke group structuring the closed loop and the stroke group that is present within the aforementioned stroke group.

The extractor 1017 extracts a first structural element from the second specifying data recognized by the recognizer 1014, based on the first specifying data recognized by the recognizer 1014. Additionally, in the case where a difference is caused by modification due to recognition error of the recognizer 1014, the extractor 1017 does not extract the structural element with the difference as the first structural element.

For example, it is assumed that a handwritten structural element in specifying data is not recognized as intended by the user, and recognition is performed as intended by the user after the structural element is rewritten. In this case, it is not desirable if a difference is extracted with the structural element of the first specifying data being treated as a structural element that is not recognized as intended by the user and the structural element of the second specifying data being treated as a structural element that is recognized as intended by the user.

Accordingly, the extractor 1017 first calculates the similarity between a stroke group of a structural element which is a structural element of the first specifying data and which is not recognized as intended by the user and a stroke group of a structural element which is a structural element of the second specifying data and which is recognized as intended by the user, and if the similarity is at or above a threshold value, the extractor 1017 does not extract the structural element with the difference as the first structural element.

That is, if the similarity of structural elements between which there is a difference is at or above a threshold value, the difference is determined to have been caused by modification due to recognition error of the recognizer 1014, and extraction of the first structural element is performed again with the specifying data before input of the structural element which is not recognized as intended by the user as the first specifying data.

Additionally, calculation of the similarity between stroke groups is disclosed in Tomoyuki Shibata et al.: “Fast and Memory Efficient Online Handwritten Strokes Retrieval Using Binary Descriptor”, ACPR2013, 2013, for example.

The changer 1019 changes the weight of the item which is the difference of the first structural element extracted by the extractor 1017. Additionally, in the case where it is recognized by the recognizer 1014 that increase is specified for the first structural element, the changer 1019 increases the weight of the item which is the difference of the first structural element, and in the case where it is recognized by the recognizer 1014 that decrease is specified for the first structural element, the changer 1019 reduces the weight of the item which is the difference of the first structural element.

Also, in the case where a first structural element with two or more modified items, among the area, the attribute, the color, and the keyword, is extracted by the extractor 1017, the changer 1019 changes the weight of an item, among the two or more items, for which the degree of modification is above a threshold value (an example of a third threshold value).

For example, it is assumed that, at the time of modification, in the second specifying data, of the attribute of a structural element of the first specifying data, not only the attribute of the structural element but also a part of the area are deleted, and thus the attribute of the structural element and the part of the area are rewritten. In this case, it is against the intention of the user to change the weight for the area of the structural element. Accordingly, in the case where a first structural element with two or more modified items is extracted, the changer 1019 changes the weight of the item, among the two or more items, whose degree of modification is above a threshold value. It is thus possible to prevent rewriting to be taken as modification. Additionally, the degree of modification is normalized, as described in the first embodiment, and thus the threshold may be used in common for the items.

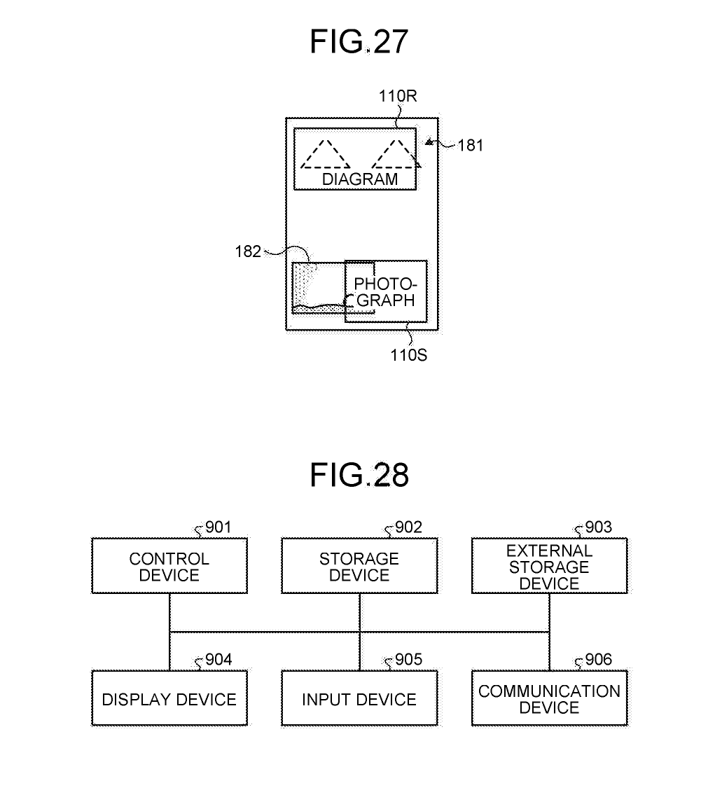

The display controller 1025 displays the content retrieved by the searcher 23 on the display 27 (for example, the search result display area 108 in FIG. 2). Additionally, as illustrated in FIG. 27, the display controller 1025 may display a handwritten structural element by superimposing the same on the retrieved content. In the example illustrated in FIG. 27, handwritten structural elements 110R and 110S are displayed being superimposed on content structured by structural elements 181 and 182.

As described above, the same effect as the first embodiment may be achieved by the second embodiment.

### Example Modification 3

Specification of the amount of change in the weight, the process for causing rewriting to be not taken as modification, and the like described in the second embodiment may be performed in the first embodiment.

### Example Modification 4

In each of the embodiment described above, description is given citing an example where the search device includes the second storage, but the second storage may alternatively be provided outside the search device (for example, in cloud). Also, components of the search device, other than the second storage, may be placed in cloud, or they may be distributed over a plurality of devices to realize the search device.

Hardware Configuration

FIG. 28 is a diagram illustrating an example hardware configuration of the search device according to each embodiment and each example modification described above. The search device according to each embodiment and each example modification includes a control device 901 such as a CPU, a storage device 902 such as a ROM or a RAM, an external storage device 903 such as a HDD, a display device 904 such as a display, an input device 905 such as a keyboard or a mouse, and a communication device 906 such as a communication interface, and has a hardware configuration that uses a regular computer.

Programs to be executed by the search device according to each embodiment and each example modification described above are provided being stored in a computer-readable storage medium, which may be provided as a computer program product, such as a CD-ROM, a CD-R, a memory card, a DVD (Digital Versatile Disk) or a flexible disk (FD) in an installable or executable file.

Also, the programs to be executed by the search device according to each embodiment and each example modification described above may be stored on a computer that is connected to a network such as the Internet, and be provided by being downloaded via the network. Furthermore, the programs to be executed by the search device according to each embodiment and each example modification described above may be provided or distributed via a network such as the Internet. Moreover, the programs to be executed by the search device according to each embodiment and each example modification described above may be provided being embedded in a ROM or the like.

The programs to be executed by the search device according to each embodiment and each example modification described above have a module configuration for causing each unit described above to be realized on a computer. As the actual hardware, each unit is realized on the computer by the CPU loading the programs into the RAM from the HDD and executing the same.

For example, the order of execution of the steps in the flow chart of the first embodiment described above may be changed, or a plurality of steps may be executed simultaneously, or steps may be executed in a different order at each execution, as long as such execution is not contrary to the essential nature of the steps.

As described above, according to each embodiment and each example modification described above, content may be searched for while easily reflecting the intention of a user in the weight of one or more items of each of one or more structural elements used or search.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A search device comprising:
a receiver that receives input of first specifying data that specifies at least one item comprising an area, an attribute, a color, or a keyword of each of one or more structural elements, and, subsequent to receiving the first specifying data, the receiver further receiving input of second specifying data obtained by modifying the first specifying data;
an extractor that extracts a first structural element having a difference in the second specifying data from the first specifying data;
a changer that changes a weight of an item corresponding to the difference of the extracted first structural element;
a searcher that searches for content based on an item of the first structural element, the changed weight of the item of the first structural element, an item of a second structural element that does not have a difference in the second specifying data from the first specifying data, and a weight of the item of the second structural element; and
a display controller that displays the content on a display.

2. The device according to claim 1, further comprising a first storage that stores the first specifying data, and weight information indicating a weight of an item of each of the one or more structural elements, wherein
the receiver receives input of the second specifying data after input of the first specifying data,
when the weight information indicates the weight of an item corresponding to the difference of the first structural element, the changer changes the weight,
when the weight information does not indicate the weight of the item corresponding to the difference of the first structural element, the changer changes a default weight, and
the weight of the item of the second structural element is indicated by the weight information.

3. The device according to claim 1, wherein when the item corresponding to the difference of the extracted first structural element is the area, the changer changes a weight of the area.

4. The device according to claim 1, wherein when the item corresponding to the difference of the extracted first structural element is the attribute, the changer changes a weight of the attribute.

5. The device according to claim 1, wherein when the item corresponding to the difference of the extracted first structural element is the color, the changer changes a weight of the color.

6. The device according to claim 1, wherein when the item corresponding to the difference of the extracted first structural element is the keyword, the changer changes a weight of the keyword.

7. The device according to claim 1, wherein the changer changes the weight of the item corresponding to the difference of the extracted first structural element by a specific value.

8. The device according to claim 1, wherein the changer changes the weight of the item corresponding to the difference of the extracted first structural element according to a degree of modification of the item.

9. The device according to claim 1, wherein
the second specifying data further specifies an increase or a decrease of the weight of the item,
when the increase is specified, the changer increases the weight of the item corresponding to the difference of the extracted first structural element, and
when the decrease is specified, the changer reduces the weight of the item corresponding to the difference of the extracted first structural element.

10. The device according to claim 1, further comprising a second storage that stores a plurality of pieces of content, wherein
the searcher, for each of the plurality of pieces of content:
calculates a first similarity to the item of the first structural element,
multiplies the first similarity by the changed weight of the item of the first structural element to obtain a first weighted similarity,
calculates a second similarity to the item of the second structural element,
multiplies the second similarity by the weight of the item of the second structural element to obtain a second weighted similarity,
calculates a likelihood based on a mean of the first weighted similarity and the second weighted similarity, and
searches for content whose likelihood exceeds a first threshold value among the plurality of pieces of content.

11. The device according to claim 10, wherein the searcher calculates the first similarity to the item of the first structural element by a similarity calculation method according to a degree of modification of the item.

12. The device according to claim 11, wherein when the degree of modification is smaller than a second threshold value, the searcher calculates the first similarity by a similarity calculation method by which a similarity is not easily increased.

13. The device according to claim 12, wherein when the degree of modification is equal to or greater than the second threshold value, the searcher calculates the first similarity by a similarity calculation method by which a similarity is easily increased.

14. The device according to claim 10, wherein the display controller displays, by superimposing on the content, at least one of the first structural element and the second structural element.

15. The device according to claim 1, wherein
the first specifying data and the second specifying data are handwritten data,
the device further comprises a recognizer that recognizes the first specifying data and the second specifying data received by the receiver, and
the extractor extracts the first structural element from the second specifying data recognized based on the recognized first specifying data.

16. The device according to claim 15, wherein
the recognizer further recognizes a specification of an increase or a decrease of the weight of the item for each of the one or more structural elements, and
when the specification of the increase for the first structural element is recognized, the changer increases the weight of the item corresponding to the difference of the first structural element, and
when the specification of the decrease for the first structural element is recognized, the changer reduces the weight of the item corresponding to the difference of the first structural element.

17. The device according to claim 15, wherein when the difference is caused by modification due to recognition error of the recognizer, the extractor does not extract the structural element having the difference as the first structural element.

18. The device according to claim 15, wherein when the first structural element having two or more modified items among the area, the attribute, the color, or the keyword, is extracted by the extractor, the changer changes a weight of at least one of the two or more items for which a degree of modification is greater than a third threshold value.

19. A search method comprising:
receiving input of first specifying data that specifies at least one item comprising an area, an attribute, a color, or a keyword of each of one or more structural elements;
receiving input of second specifying data obtained by modifying the first specifying data;
extracting as a first structural element having a difference in the second specifying data from the first specifying data;
changing a weight of an item corresponding to the difference of the extracted first structural element;
searching for content based on an item of the first structural element, the changed weight of the item of the first structural element, an item of a second structural element that does not have a difference in the second specifying data from the first specifying data, and a weight of the item of the second structural element; and
displaying the content on a display.

20. A computer program product comprising a non-transitory computer-readable medium containing a program executed by a computer, the program causing the computer to execute:
receiving input of first specifying data that specifies an item comprising an area, an attribute, a color, or a keyword of each of one or more structural elements;
receiving input of second specifying data obtained by modifying the first specifying data;
extracting, a first structural element having a difference in the second specifying data from the first specifying data;
changing a weight of an item corresponding to the difference of the extracted first structural element;
searching for content based on an item of the first structural element, the changed weight of the item of the first structural element, an item of a second structural element that does not have a difference in the second specifying data from the first specifying data, and a weight of the item of the second structural element; and
displaying the content on a display.
